(19) United States
(12) Patent Application Publication
(10) Pub. No.: US 2014/0067660 A1
(43) Pub. Date: Mar. 6, 2014

(54) Method and process for an electric vehicle charging system to automatically engage the charging apparatus of an electric vehicle

(71) Applicant: Kevin Terrill Cornish, Berkeley, CA (US)

(72) Inventor: Kevin Terrill Cornish, Berkeley, CA (US)

(21) Appl. No.: 13/987,944

(22) Filed: Sep. 18, 2013

Related U.S. Application Data
(63) Continuation-in-part of application No. 13/385,620, filed on Feb. 27, 2012, now abandoned.
(60) Provisional application No. 61/464,888, filed on Mar. 11, 2011.

(51) Int. Cl. G06Q 20/14

(52) U.S. Cl. CPC G06Q 20/145
USPC 705/39

(57) ABSTRACT

An automated vehicle charging system, that may be done within a service type station, to provide for charging, recharging, or even discharging, of the batteries of an electric vehicle, and generally will include a dispenser, having a cabinet containing all of the instrumentation desired for furnishing the provision of current information relative to the charging of a vehicle, of otherwise, and will include boom means that are highly maneuverable, in order to bring the charging instrument into close proximity of the electrical receptacle of the vehicle being serviced, whether it be at a service type station, or at a curbside type of charging system. Robotics may be used within the structure of these electrical charging systems, to facilitate the charging of any vehicle, by the customer itself, even at a self service type of station.

### CROSS REFERENCE TO RELATED APPLICATION

This continuation-in-part patent application claims priority to the non-provisional patent application having Ser. No. 13/385,620, filed on Feb. 27, 2012, which claims priority to the provisional patent application having Ser. No. 61/464,888, filed on Mar. 11, 2011.

### FIELD OF THE INVENTION

The concept of this invention is to provide a system of electrical vehicle charging that will either automatically engage or electrically connect with an electric vehicle once it is within a defined range of the charger, and incorporates means for identification, charging of the vehicle, or discharging for credit, to facilitate and encourage the widespread usage of electric vehicles (EV) in society.

### BACKGROUND OF THE INVENTION

Research has been conducted regarding electric vehicles dating back to the year 1832, when Scottish born Robert Anderson invented the first crude electric carriage powered by non-rechargeable primary cells, and related research continues to this day. Periods of intense investigation, based upon impetus such as pollution concerns, government regulation and, most importantly, rapidly rising costs of fossil fuels, has historically been followed by waning interest (as fuel prices have historically declined to an acceptable norm).

Primary concerns with electric vehicles involve (a) the range, in terms of total miles or kilometers, that a fully charged vehicle can travel prior to requiring an additional charge (b) the time required to fully recharge the vehicle (c) the availability of adequate recharging facilities along the roadways (d) the human safety aspects of engaging a charging apparatus and the potential adverse effects of battery ruptures or explosions and (e) the environmental impact of depleted batteries.

Much research has been conducted to enhance the energy storage capabilities of plug-in electric vehicles (PEVs) or plug-in hybrid electric vehicles (PHEVs). Through the American Recovery and Reinvestment Act of 2009, the Office of Energy Efficiency and Renewable Energy (U.S. Department of Energy) has set aside funding in excess of $2 billion for a combination of battery development and the construction of battery manufacturing infrastructure in the U.S. Much of the research involving batteries is aimed at devising the best possible chemical composition/battery construction to allow for the maximum range of a vehicles travel prior to another required charging session.

According to the Silicon Valley Chapter of the Electric Automobile Association (EAA), 90% of cars in the U.S. travel less than 30 miles per day. The EAA statistics also indicate that the average EV travels 60 miles on a single (full) charge, suggesting that an EV would require a full recharge, on average, every other day.

A survey conducted by the Electric Power Research Institute (EPRI) revealed that nearly all potential EV purchasers expect to charge their vehicles at home, the concept of nighttime charging is acceptable to over 80% of the respondents, and nearly two-thirds stated that a conventional 120 volt electricity outlet was located within 25 feet of the location where their EV would be parked at their residence.

Residential charging is envisioned as a process whereby the EV owner collects a cable or extension cord, which on one end has a charging connector that is compatible with the EV receptacle, and the other end either hardwired into an AC/DC converter or the wiring of the residence (if an AC/DC converter is embedded within the EV) or, more likely, consisting of 110/120V (or perhaps a 220/240V) male plug that can be inserted into an AC outlet (assuming AC/DC conversion occurs along the way to the EV battery).

Charging at a location that is remote from the residence may occur by engaging with an acceptable/authorized charging station, or by simply plugging in to any lawfully available outlet.

A study conducted among automobile industry executives and consumers indicates consensus between those broad groups that the number one driver supporting adoption of electric vehicles is the concern over the price, and the volatility of the price, of oil. The concept of driving electric vehicles is also gaining popularity among environmentally conscious peoples as a means of reducing carbon emissions.

Unfortunately, the potential benefits of EVs are currently overshadowed by one clear negative, best described as “range anxiety”. In order to overcome the anxiety that drivers are expected to suffer from potentially traveling to an area where charging equipment is not available, and as a consequence there is not sufficient “fuel” to return to a known charging location, the Electrification Coalition has developed an Electrification Roadmap that proposes a plan for a nationwide system of vehicle charging stations. The Roadmap forecasts that by the year 2030 the U.S. could require as many as 25 million public charging stations (in addition to a staggering number of home based charging stations) at a projected (maximum) installed cost of some $300 billion.

Until such time as the national charging infrastructure is built out, range anxiety will likely persist, in part due to the fact that the EV charging connector is unique (as compared to the typical two or three prong extension cord male/female configuration). The current “standard” for the conductive EV charging connector that has been adopted by a majority of EV manufacturers in the U.S., and likewise by charging station manufacturers, is known as the Society of Automotive Engineers (SAE) J1772 connector.

Unfortunately, even in the U.S. there is not a single standard, as the following Charging Station Selector Guide indicates (i.e., Residential v. Commercial Level I v. Commercial Fast Charging at 125 A):

Charging Station Selector Guide

| | | | | | Mounting | |
|---|---|---|---|---|---|---|
| Model | Application | Level | Power | Connector | Options | Region |
| [symbol] CT500 | Residential | Level II | ≦ 208/240 VAC | SAE J1772 ™ | [symbol] Wall | North America |
| | | | [symbol] 30 A | | | |
| [symbol] CT1000 | Commercial | Level I | [symbol] 120 VAC | Nema 5-20 outlet | [symbol] Wall | North America |
| | | | [symbol] 16 A | | [symbol] Pole | |
| | | | | | [symbol] Bollard | |
| [symbol] CT1500 | Commercial | Level I | [symbol] 230 VAC | [symbol] Shuko | Wall | Europe |
| | | | [symbol] 16 A | BS | [symbol] Pole | |
| | | | | [symbol] AUZ | [symbol] Bollard | |
| [symbol] CT2000 | Commercial | Level II | [symbol] 208/240 VAC | SAE J1772 ™ | [symbol] Wall | North America |
| | | | [symbol] 30 A | | [symbol] Pole | |
| | | | | | [symbol] Bollard | |
| [symbol] CT2100 | Commercial | Level I | [symbol] 120 VAC | Nema 5-20 outlet | [symbol] Wall | North America |
| | (dual output) | | [symbol] 16 A | | [symbol] Pole | |
| | | Level II | [symbol] 208/240 VAC | SAE J1772 ™ | [symbol] Bollard | |
| | | | [symbol] 30 A | | | |
| [symbol] CT3000 | Commercial | DC Fast Charging | [symbol] 240-500 VDC | [symbol] SAE J1772 ™ | | North America |
| | | | [symbol] 125 A | [symbol] TEPCO-JARI | | |

The majority of EV charging stations that (a) have been deployed (b) are under contract to be deployed and (c) are expected to be deployed in the very near term involve (i) a conductive charging method, (ii) a standard based connector that is appropriate for the EV expected to be charged and (iii) a process of manually engaging/connecting the charging apparatus to the EV by means of an extension cord (much like the use of the hose/pump handle configuration of a typical gasoline filling station).

However, exceptions to the typical EV charging station approach exist and are under serious consideration, including:
A) An inductive charging—or wireless—process, and
B) An automated process (for public transit buses)

Some prior art patents that relate to automatic charging of electrically powered vehicle can be seen in the published Brown Application No. US 2010/0235006, incorporates its own structural devices to automatically charging an electric powered vehicle.

The published application to Johnson, No. US 2009/0021213, is a Method for Pay-Per-Use, Self-Service Charging of Electric Automobiles.

Finally, the published application to Fincham, et al, No. US 2010/0017249, may show a system for electrical vehicle charging and power management, and primarily relates to the customizing of a charging process for an electric automobile, as can be noted. Fincham shows nothing of the structure of the system of applicant's invention, in utilizing a five axes movement to engage an automated vehicle charging system with an electric vehicle. Fincham may state that his system may allow a vehicle to sell energy, but that appears to be the only relationship to the current invention described herein.

### SUMMARY OF THE INVENTION

The typical EV charging station requires the EV owner to proactively remove the charging “nozzle” or adapter, which is tethered by an extension cord, and connect the device to the EV's built in charging socket. A variety of marketing material, from some of the most notable charging station manufacturers, depicts various methods for storing the EV charging station cord, including: flexible recoiling cords and the “wind it up yourself” variety. These charging stations require that the EV owner (or possibly a public parking lot attendant) to remove the connector from the EV and replace the cord once charging is complete.

The marketing material for each of the public charging station manufacturers presents their product being utilized in the best of possible environmental conditions: a sunny day heading to the beach, or a bright starry night in some urban entertainment district. Unfortunately, even in Southern California, the weather is not always perfect.

Consider the potential for a weather pattern that brings extended torrential downpours, or perhaps several inches of snow. Picture the EV owner commuting twenty five miles to work in a large city. Traffic has been jammed, and so he/she is already late for a big meeting upon arriving at the public parking lot that offers EV charging which, unfortunately, is an additional five minute walk to the office building destination—but one has no choice due to the fact that EV charging infrastructure is not yet ubiquitous throughout the city. Further, one has no choice but to re-charge the EV; otherwise, one won't be able to make it home that evening (i.e., range anxiety). There are three inches of snow on the ground, it is 20 degrees Fahrenheit, and a steady cross wind is blowing at 10 mph—gusting up to 18 mph. This EV owner vows to theirself to exchange the EV for an SUV that weekend, as one attempts to untangle the charging station cord, brace oneself against the cross wind as he/she struggles, and somehow maneuver the SAE J1772 connector (configured much like the child-proof caps on containers of medicine) into the EV charging socket.

Or, alternatively, consider a bright sunny New York day in the year 2020. Commuters or commercial delivery has, by this time, adopted EVs in droves. The city has installed enough charging stations around New York to accommodate all of the EVs. A significant assumption that supported the economics of the city's EV charging infrastructure deployment business plan was the ability to draw on EVs—to give power back to the grid—in times of critical peak demand. In the business plan, EVs were considered to be “distributed generation” resources well suited for demand response situations.

Now, assume that a heat wave has gripped the city for a week, and on this day, temperatures are expected to reach 102 degrees Fahrenheit. HVAC units are straining to cool and dehumidify the large buildings in the city, drawing more power from the grid than usual. City planners expect that tapping into the EV reserve will lighten the load on the overburdened electricity grid. Unfortunately, this does not happen. Only the EV owners who need a charge have taken the time/made the effort to engage the SAE J1772 connector to their EV socket. EV owners who are fully charged either (a) do not want the city to take away their power or (b) do not want to make the effort to engage their EVs.

In summary, the manual process of engaging an EV with the grid to enable charging or discharge of power will not produce satisfactory results from either (i) a consumer satisfaction or (ii) a grid stabilization (distributed generation/demand response) perspective.

The inductive method of charging—whereby an EV owner simply parks the vehicle in close proximity to a charging station and charging is accomplished “wirelessly”—holds much more promise for the EV owner in terms of consumer satisfaction, principally from an ease of use perspective. It is expected, however, that the higher cost of EV charging will dissuade potential consumers from widespread adoption of this approach. Estimates of energy transfer loss of 10%, as compared to conductive charging methods, have been cited by proponents of inductive charging. And while it is expected that inductive charging stations will be able to accept energy discharge from EVs in response to distributed generation/demand response requests, you can expect at least as much energy transfer loss if/when the EV discharges.

In summary, from an economics and/or societal perspective, the EV owner would prefer to conductively charge his or her EV so as to save money and prevent waste. And while inductive charging may be appealing from an “ease-of-use” perspective, an automated conductive charging approach is likely to sway consumers.

Discussion of automated conductive charging has been limited so far to very modest disclosures targeted to metropolitan transit. Searches of publicly available information have identified only a single animated presentation relating to planned electric bus charging stations, whereby the charging station communicates with the driver of the bus so that the vehicle is aligned with the station's extension arm. The extension arm is to be affixed with a suitable connector (not SAE 1772 compliant) that—once the bus is aligned—will enter the bus' receptacle. The station appears to be a “quick charge only” station that is designed for one way charging only. The system is designed for side only, on top charging of city transit buses.

While the automated conductive charging approach described is appealing for its specific design, it does not address the more compelling issues that will be associated with widespread adoption of consumer level EVs; namely: (i) the EV station will need to automatically align itself with the vehicle charging receptacle (i.e., the inverse of the bus charging disclosure), so that the EV driver need only park within a reasonable proximity to the conductive charging station (much like the inductive charging concept), (ii) the automated charging station will need to offer standards based charging connectors (e.g., the SAE J1772 adapter) and, once so aligned, the extension apparatus should be capable of performing the machinations required for a safe/proper connection to the EV (recall the safety cap on the pill bottle . . . ) and (iii) the station must be capable of providing a charge, accepting an EV discharge, and calculating any net or negative accounting/billing of energy costs attributable to the energy flows.

It is, therefore, the principal object of this invention to provide the availability of a charging station, that can be used for recharging of the batteries of any electric operative vehicle when properly equipped, and to provide for identification of the vehicle and the vehicle owner and/or a person taking responsibility for the vehicle (e.g., a renter's identification), and to further provide for debiting and/or crediting to the vehicle owners' (or the responsible consumer's) debit or credit account of charges to or discharges of energies from the vehicle, and to determine the condition of the vehicles operation when located within the vicinity and/or hooked up to a recharging station during operation.

Another object of this invention is to provide for the entire mechanisms for providing charging to an electric vehicle.

Another object of this invention is to provide a means for discharging of a vehicles battery system, when the operator wishes to receive credit for excess charge, when the system is in need of additional electrical energy.

These and other objects may become more apparent to those skilled in the art upon review of the summary of the invention as provided herein, and upon undertaking a study of the description of its preferred embodiments, in view of the drawings.

### BRIEF DESCRIPTION OF THE DRAWINGS

In referring to the drawings,

FIG. 1 provides a schematic view of an automated vehicle charging system of this invention;

FIG. 2 provides a schematic of a charging system that incorporates various drive mechanisms for positioning the connectable charging instruments within the vicinity of the vehicle to be recharged;

FIG. 3 provides a schematic of the robotic arm configurations for use for modified identification and charging of a vehicle, during usage of the system of this invention;

FIG. 3a shows a schematic of the motions provided by the robotic arm configuration for this system of FIG. 3;

FIG. 4 shows a curbside type of robotic arm configuration for a more simple recharging system for an electric vehicle;

FIG. 5 depicts the algorithm for engaging the electric vehicle charging system; and

FIG. 6 is a continuation of the FIG. 5 algorithm.

### DESCRIPTION OF THE PREFERRED EMBODIMENT

The new system of electric vehicle charging will automatically engage with an electric vehicle once the EV is within a defined range, space or field of reach of the charging station. By doing so, the EV will be engaged with the grid as an asset capable of providing energy (by way of discharge) in the event of a grid crisis, without the need for the EV owner to proactively connect his or her vehicle.

Further, by virtue of the automatic engagement of the charging station with the vehicle, EV owners will free themselves of exposure to the elements of inclement or unsettled weather.

The invention overcomes the limitations and weaknesses of the current art through the following:
1. The Automated Vehicle Charging System (AVCS) will include motion sensors and/or cameras to detect the presence of a vehicle within its service territory. Upon detection of a vehicle, the AVCS will issue a request for information from the EV using its radio frequency based two way communications capability. The radio communication request for information should be directed to the target EV (within its immediate proximity), and may use one or more of a variety of means to determine if it is communicating with the target vehicle, including (but not limited to):
   The preferred method: an Optical Recognition Method (e.g., camera/optics that identifies the vehicle license plate number) coupled with a radio frequency based transmission from the EV which includes an identification acknowledgement that confirms or corroborates the recognition criteria (e.g., license plate number).
   A Least Latency Analysis, wherein the system (through a series of requests and related response timing) identifies the vehicle based upon time synchronization of RF returns in conjunction with sensor analytics.
   Global Information Satellite longitude/latitude confirmation processes.
Once RF communications are established with the target vehicle, which may be based upon one or more standards based communications protocols (such as Bluetooth, Wi-Fi or Zigbee, satellite or even cellular), the system will identify, via communications with the EV, the appropriate charging adapter (e.g., the SAE J1772 connector, an inductive charging pad, etc.). Also, the AVCS will confirm with the EV the direction that the car is facing along with confirmation of the fixed location on the EV of the nearest charging receptacle, thereby approximating the location that the AVCS positioning boom or robotic arm must move in order to engage with the EV charging receptacle.
(Note: while not necessary, it is envisioned that EV manufacturers will ultimately place two separate charging receptacles on all EVs: one at the rear of the EV (driver's side) and one on the front quarter panel of the EV (passenger side). This configuration should allow the EV to be charged by the AVCS whether engaging with the AVCS space face forward or by backing in, but in addition, should allow curbside charging for parallel parkers. Moreover, this approach should allow the EV owner an option should one of the charging receptacles become damaged or otherwise becomes temporarily inoperable).
2. Once the AVCS and the EV have established communications and have determined that the available charging connector is compatible with the EV receptacle, the boom (or a robotic arm) will extend towards the area of the EV that has been identified to contain the charging receptacle. It is expected that the AVCS will offer only one type of charging adapter, but in a more sophisticated embodiment of the AVCS, a variety of charging adapters may be available for quick connect/change out to a standardized fitting on the boom's retractable charging connector apparatus (or the robotic arm's extremity point).
3. The boom connector apparatus (or robotic arm extremity point) will advance towards the general location of the EV receptacle (in terms of height, in particular, as it is expected that front charging receptacles may typically be located at a certain height (e.g. around 24 inches above the ground for front charging receptacles, whereas rear charging receptacles may be located at a typical height of (e.g., 36″ above the ground)), and will then engage in a patterned search for the vehicle charging receptacle. The connector apparatus (or robotic arm extremity charging apparatus) will contain one or more alignment device(s) that may utilize any or all of cameras, lasers, radar, or other developed processes to allow the boom's retractable charging apparatus (or robotic arm apparatus) to accurately align the charging connector with the EV receptacle.
4. The EV charging receptacle cover shall be moved aside or removed by either automated means (i.e., the EV issues a command to disengage the latch on a spring loaded or hydraulic cover) or a mechanical process. If a mechanical opening process is necessary, such that the boom or robotic arm must non-abrasively open or reposition the receptacle cover, the EV must contain a fixed alignment point, preferably in close proximity to the charging receptacle, that will allow the robotic arm to precisely locate the preferred point of contact so that the programmed action of opening may occur without incident. The fixed alignment point may take the form of a Light Emitting Diode, a translucent marker, or any other permanently affixed point that can be detected by the boom's or robotic arm's alignment apparatus.
5. Once the EV charging receptacle cover has been set aside, and the AVCS's boom connector apparatus or robotic arm has aligned the appropriate charging connector with said receptacle, the AVCS will guide the charging connector into a position to dock with the EV. The machinations that are required for the connector to make the necessary connection with all of the EV receptacle contact points will be carried out by the AVCS connection program software in conjunction with feedback from the alignment device. The AVCS will run a system check to ensure that the connector contacts are properly seated, and if the EV system allows for similar feedback through its internal EV charging analytics, such feedback will be communicated to the AVCS for confirmation. The EV confirmation represents a safety check that will be redundant to the AVCS analysis, and so will not necessarily represent a critical action required to initiate a charge, or accept a discharge.
6. The AVCS will consist of an enclosure that houses:
   (a) a battery that is capable of providing power to:
      (i) the onboard computer and/or
      (ii) the EV in the case of primary (i.e., grid) power failure
   (b) an onboard computer that can perform any or all of the following functions:
      (i) processes sensor inputs and aligns the boom or robotic arm so that the connector can engage with the EV receptacle by means of controlling the motors, boom related drive chain/gear systems and/or robotic arms (as the case may be)
      (ii) communicates with the EV via wireless RF (and wired communication should the EV connector protocols provide for that medium)
      (iii) positively identifies the vehicle (via some combination (one or more of) license plate recognition, vehicle identification number, vehicle body style/dimension recognition, credit card information and owner password)
      (iv) initiates connect/disconnect procedures
      (v) controls interactions with the AVCS payment terminal (which may be necessary if the preprogrammed payment credentials are not accepted or not available) and processes transactions through the terminal user interface
      (vi) accepts updates to electric charging rate plans from authorized sources
      (vii) calculates billings based upon energy flows to the EV, energy discharges from the EV, or both i.e. net billing; and potentially other charges (such as parking fees, excise taxes, community charges, etc), such billings otherwise known as Net Metering, as there is the potential that the EV owner receives a net credit for engaging with the AVCS should the calculated credit for energy discharge from the EV exceed other charges
      (viii) initiates charging, discharging, or no charging (as may be the case if the EV has received a full charge or additional charging is not necessary based upon the economics of the rate schedule), controls the charging process (e.g., quick charging or standard charging when applicable power is available) and controls the type of energy flow (AC vs. DC; and if DC, controls the converter or inverter as the case may be) and
      (ix) performs system diagnostics on the overall charging operation (which may include individual asset performance, connector efficiency, malfunction alarms, battery backup status, etc.) and
      (x) provides system security (firewalls, virus protection, tamper detection, physical alarms for vandalism, etc.),
   (c) a Payment Terminal that includes an information display, an input keypad, a credit card reader, possibly a currency/coin acceptor (and change refunding apparatus), possibly a speaker and microphone, a camera, and a receipt dispenser; and which functions as a user interface to accept payment, select a particular charging scheme (assuming alternate plans are offered), and to communicate with users should difficulties arise with selection of payment schemes, acceptance of payment, or malfunctions with charging apparatus require immediate attention from a service technician.
   (d) A camera or proximity type sensor, or a plurality of cameras and/or sensors to (in addition to functioning as a means of user interface) assist in triangulating the presence and location of the EV.
   (e) At least one motor that will be engaged in the positioning of the EV charging connector apparatus.
   (f) A connector and positioning sensor receptacle that will house the connector(s) and related positioning apparatus when not in use, thereby providing shelter/protection to the unit so that damage will not occur to the part of the AVCS that couples with the EV (consequently, providing a measure of protection to the EV).
7. The AVCS will consist of a means of extending the EV charging connector apparatus towards the EV, including the following:
   (a) For public parking locations other than curb-side/parallel parking:
      (i) An overhead boom configuration whereby the charging cables (or the extension hardware itself) would not impede human traffic (as depicted in Diagrams 1 and 2—See Drawing Section (below)). This would be the preferred embodiment of the AVCS.
      (ii) A robotic arm configuration (examples as depicted in Diagram 3), in place of the boom configuration, but governed by the AVCS system described in item 6 (above).
   (b) For public curb-side parallel parking, it is envisioned that a robotic arm configuration will be preferable (as depicted in Diagram 4), in spite of the impediment to pedestrian thoroughfare associated with the AVCS extension protruding at potentially midriff or knee level from the AVCS to the EV, given the following:
      (i) The robotic arm would be retractable (stored inside of the enclosure), thus increasing the aesthetic presentation of the AVCS and consequently lessening the degree of pedestrian impediment whilst not in use.
      (ii) The charging cable would otherwise be extended to the EV or lying on the ground, also presenting a potential pedestrian impediment or tripping hazard.
   (c) For residential usage, depending upon the EV charging location desired, the AVCS may be configured using either a boom configuration or a robotic arm configuration, at the EV owner's discretion.
8. The AVCS may include charging alignment apparatus and software, as follows:
   (a) A camera, sensor, laser or radar detection device, or a plurality of such cameras, sensors or devices, that will allow images or data to be transmitted to the onboard computer, whereupon system software will calculate the machinations required for the charging connector to be placed in near immediate contact with the EV charging receptacle.
   (b) The AVCS onboard computer will access code that will govern the machinations required of the ACVS charging connector, based upon the design of the required connector, in order to make a smooth and appropriate coupling to the EV receptacle.
   (c) Diagnostics firmware which will determine if all of the charging coupler connections have seated properly, and will report the findings to the control software program.
9. The AVCS will communicate with the EV to determine the type of charge required (e.g., quick or standard; AC or DC), the level of charge required, and price sensitivity settings as indicated by the EV owner. The AVCS onboard computer and control software will process the information communicated by the EV, and will initiate the charge as indicated by the communicated parameters.
10. The AVCS will be configured to disengage from the EV upon detection of engagement of the EV motor starter or perhaps occupancy of the EV. It is expected that the EV manufacturers will put in place safety features that will prevent EVs from being placed in motion until confirmation that a charging connector is not coupled to the charging receptacle.
11. The AVCS will instruct the boom extension mechanism, or robotic arm, to return to the default position (docked in the Connector and Positioning Sensor Receptacle) as soon as a disconnect event occurs. The AVCS will not attempt to reconnect with the vehicle unless the cameras/sensors (e.g. motion detector) identify the movement of the vehicle up to some set point, followed by a return of the EV. Alternatively, the EV owner could re-engage the AVCS via wireless communications or by engaging the AVCS terminal (user interface).
12. The residential configuration of the AVCS will contain fewer features (such as removal of credit card charging/payment related devices), but will otherwise include alignment sensors and positioning capabilities.
13. The AVCS will coordinate its activities with the EV Energy Management System, if available.

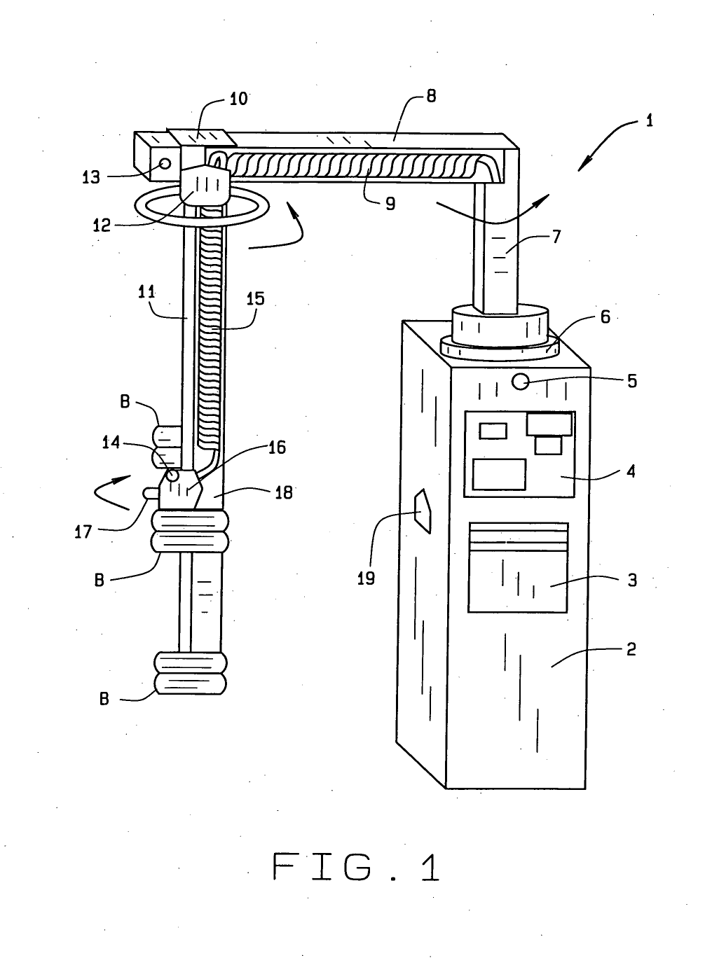

In referring to the drawings, FIG. 1 shows an automated vehicle charging system 1 for this invention. It includes the charging station enclosure 2, which may obviously take any form or shape, to provide for containment for the instrumentalities used in the operations of the charging system, and to provide for identification and debiting or crediting the customer for the energies transfer. As can be seen, the station 2 may include a charging rate schedule, on its surface, as at 3. Obviously, this may change, depending upon the cost for energy, at any given time. In the preferred embodiment, the concept of this invention envisions conductive or inductive charging or discharging, through either wired or wireless processing, of the batteries of the electric vehicle, simply by bringing the electrical connector of the charging apparatus into the vicinity of the vehicle electrical receptacle followed by an automatic engagement of the charging system which will then engage the vehicle in order to recharge or accept a discharge from the vehicle using conductive coupling (by means of a wired connection, as the preferred embodiment, or, alternatively, wirelessly through inductive coupling. In other words, the vehicle operating only need to bring the vehicle, and its electrical receptacle, into close proximity with the charging apparatus, to attain a recharging of the vehicle's batteries. And, as previously summarized, it may also include the process of discharging the batteries' stored energies back through the charging apparatus, and provide the customer with a credit for returning any such excess charge.

The terminal 4 provides for the payment terminal, a credit card reader, a keypad and display, and a receipt dispenser, similar to that which may currently be provided upon gasoline dispensers, currently in usage.

A camera/sensor 5 may be provided, for further identification of the customer, whose electric vehicle is to be serviced.

On top of the dispenser or charging station 2 may be provided with a motorized turntable 6 and which may be capable of pivoting, up to approximately 120° of pivot, during usage of the facility.

A column 7 extends upwardly, and is integrated with a boom 8 in which a coiled reflex power cable 9 may locate. At the outer end of the boom 8 is provided a mobile guide bracket 10, which pivotally connects thereto a motorized boom 11 and which may be swiveled or turned, through a positioner 12 approximately 270° of turn. There may also be a camera/sensor 13 provided at the end of the boom 8, for furnishing identification of the vehicle being serviced. Furthermore, there may be additional cameras/sensors 14 provided at the approximate level of the vehicle bumpers B for alignment and to prevent damage to the vehicle. Furthermore, the charging cable 9 extends downwardly within the supplemental boom 11, as noted at 15, and delivers electrical energy through the retractable charging system 16, as can be noted. There may be various types of connectors or inductive charging pads 17 electrically connected with the cables 15 and 9, and this device may be motorized, for elevating or lowering upon the boom 11, in order to place the charging system in close contact with the charging receptacle upon the vehicle, which may be located near the bumper, or perhaps even along the side of the vehicle, not to unlike that which may be available for the fill pipes for current gasoline driven vehicles, currently upon the market. There may be an electrical vehicle charging receptacle cover opening finger 18 as noted, and the dispenser may include a connector 19 that functions as a positioning sensor receptacle, that may include a variety of charging adaptors, and provide for automated quick connect, or disconnect, as when a charging function has been completed.

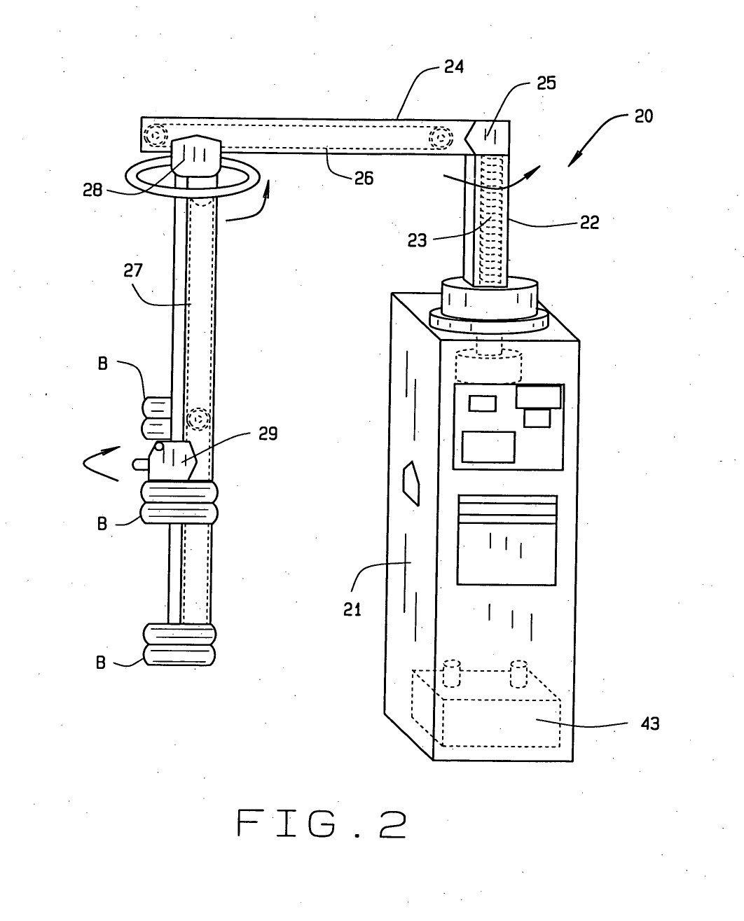

FIG. 2 shows a slightly modified vehicle charging system 20, which incorporates the dispenser cabinet 21, and which incorporates the complete control apparatuses, means, and the computer, that may provide for sensing the input and connector alignment for a vehicle, has means for providing for vehicle identification and communications, incorporates the connect/disconnect procedures, in addition to the payment terminal processing during and upon completion of charging, or even discharging. Furthermore, in may also include rate schedule updates, and further provide for visual metering and billing to show the vehicle owner exactly what charge is being processed, and the cost involved which will include all applicable state, federal, and community fees. It may also include a charge control, such as a two-way detection means, that may provide for either charge or discharge, and incorporate a charge type either of a quick, standard, dc, or ac charge to the vehicle. It may also include system diagnostics, such as to alert the driver as to the status of the vehicle, and alerts to any problems, and it may also incorporate system security, to assure that the vehicle being serviced is valid and legitimate. Furthermore, the dispenser may include a backup battery, where such may be needed for providing for the operations of its energization of a vehicle.

The dispenser cabinet 20 may also include a boom type mechanism 22 incorporating its coiled reflex power cable 23, and has a lower boom 24 operated by the positioning motor 25. It may also include a drive chain and gear system 26 internally of the boom 24, so as to both turn the extended boom 27 inwardly or outwardly, relative to the dispenser 21, and may also provide for its swiveling, through the use of a boom swivel positioning motor 28 as noted. The connector, positioning and retracting means, and the protrusion motor, as noted at 29, is similar to the retractable charging, connector or inductive charging pad 14, as previously described. The vehicle bumpers B, and their positioning relative to the boom 27, can also be seen. This provides for proper alignment of the charging mechanism 29, relative to the vehicle being charged, or perhaps even discharged, as previously summarized.

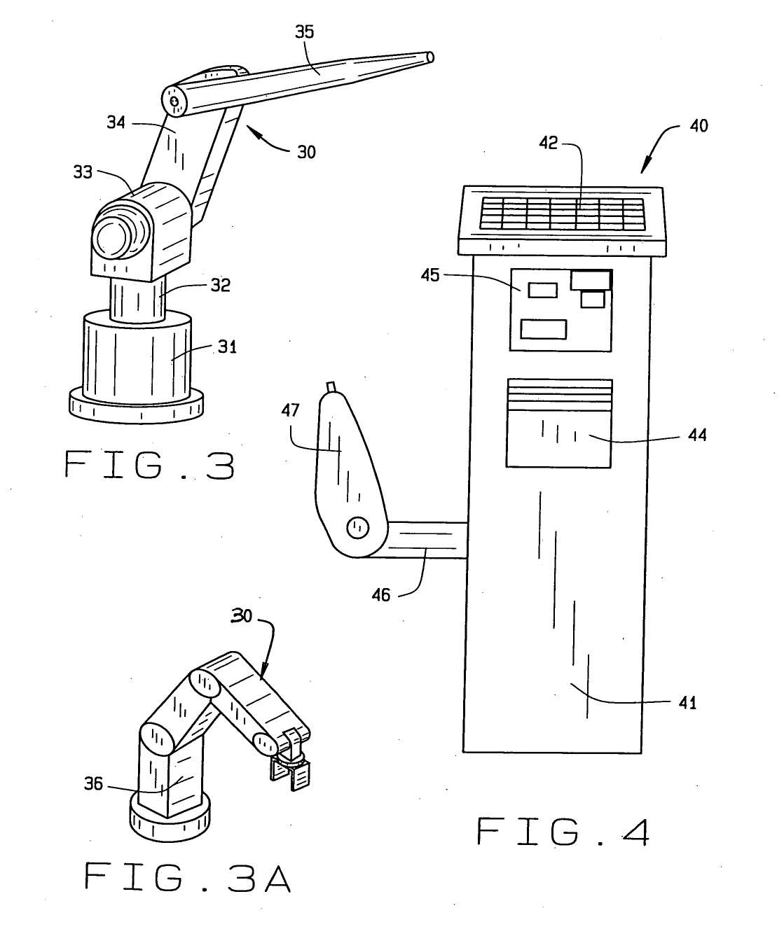

FIG. 3 shows an example of a robotic arm configuration 30, which may be used for placing the charging means within an easy access of the charging receptacle of any vehicle, to be serviced. It includes a base 31 that may include all the instrumentalities as those previously reviewed with respect to the dispensers 2 and 21. In addition, the base connects with a pivotal mount 32, which has its motorized connection 33 for positioning a main arm 34 for proper location, relative to the vehicle being serviced, and then has an extending arm 35 that may incorporate all the instrumentalities as previously described with respect to the charging connector 14, as previously explained. FIG. 3a shows a schematic as to how the robotic arm 30 can be manipulated, pivoted, rotated, in order to provide for its near automatic locating within the vicinity of the vehicle being serviced. You can also see that it may include a camera means 36, to provide for sensing and identification of the vehicle nearby, being serviced, to furnish verification of the customer, and its vehicle, being charged.

FIG. 3a shows a schematic of the various movements that can be obtained by the robotic arms of the charging apparatus, as can be noted.

The essences of this invention, in its premium form, is to provide a station where a vehicle, as an electric vehicle, may pull up to, and locate, the robotics of the dispenser, or charging station, will automatically be manipulated in the vicinity of the electrical receptor of the vehicle, and this is obtained through the use of cameras, sensors, or the like, that can detect the vehicle electrical receptor, automatically reposition the robotic arms into close proximity to the vehicle receptor, in preparation for primarily a charging function. Then, ideally, the charging station apparatus will be coupled with the vehicle receptor, at which point the vehicle may be either conductively or inductively charged, after the camera and other sensors have provided full identification of the vehicle, so that the operator need not even remove himself/herself from the vehicle, in order to primarily obtain a charging function. Also, the same facilities can be used for furnishing a discharging, where the operator may desire to sell back electrical charge to the grid, as may be desired. This is the essence of this invention, in its most improved form, to provide for complete accommodation of the electrical charging of a vehicle, of any type, that incorporates the type of recharging station operative means, as described in this application.

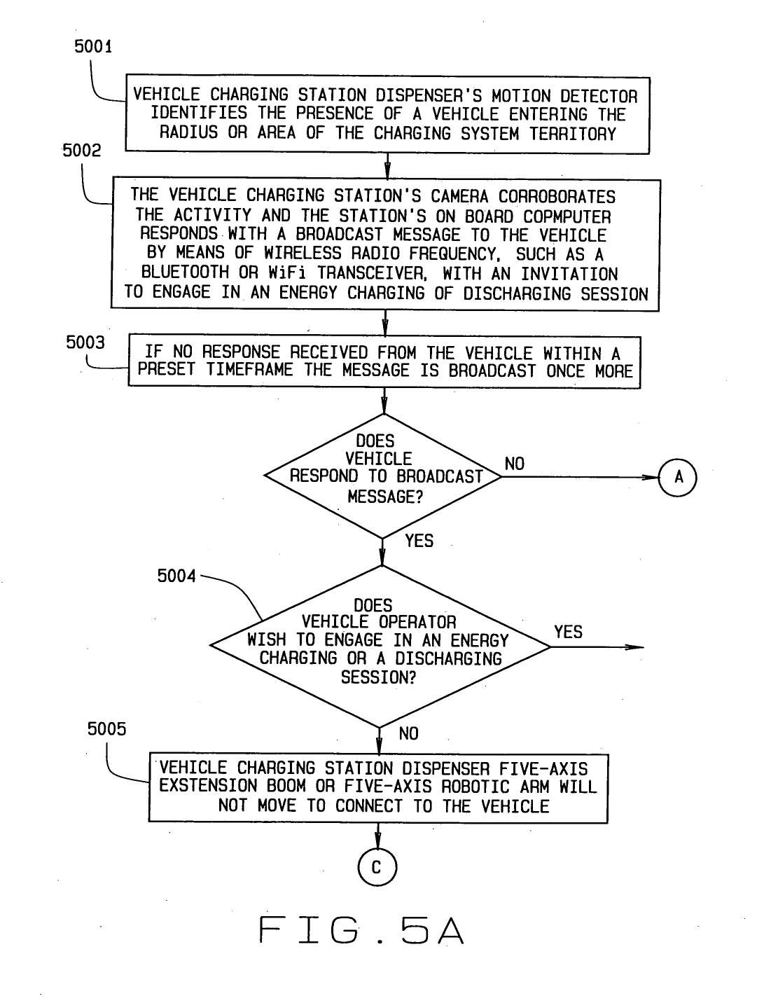

FIG. 4 shows another form of curbside robotic arm servicing means 40 which incorporates its dispenser 41, which contains all the internal components within it, similar to that as previously described with the automatic vehicle charging system of FIGS. 1 and 2. In addition, it may include a solar panel 42 in its upward regions, in order to provide for solar panel to the terminal, and to provide the functionality and power to it, as for charging/recharging of any backup battery, as previously defined at 43, within the charging system of FIG. 2. Furthermore, the charging rate schedule 44 may be provided upon its front surface, to provide current data relating to the cost of an electric charging of a vehicle. In addition, the payment terminal, card reader, and the like, can be provided at 45, upon the surface of the dispenser, as previously reviewed.

A service boom 46 extends from the dispenser 41, and it can be extended or retracted, and provide for swiveling or pivoting of its service arm 47 that can bring the plug-in mechanism, or the wireless type of charging, to the vicinity of the vehicle to be serviced. These are examples as to how these primarily charging stations may be structured, in order to furnish the type of charging, or credit for discharging, as the vehicle owner may consider, when servicing their vehicle.

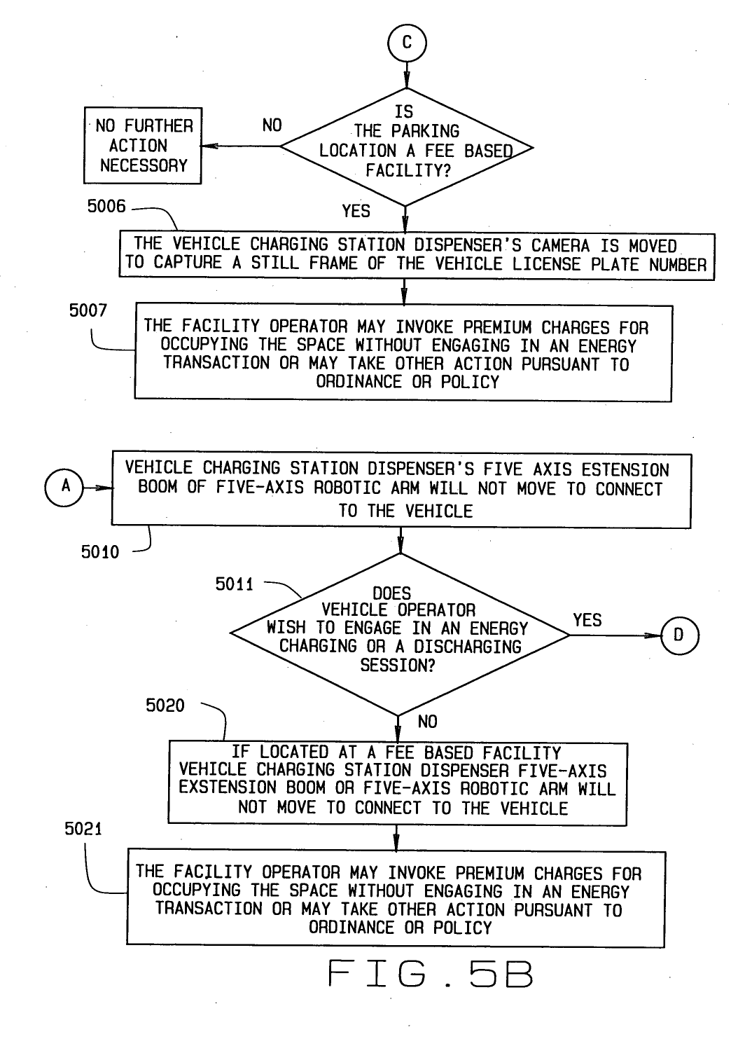

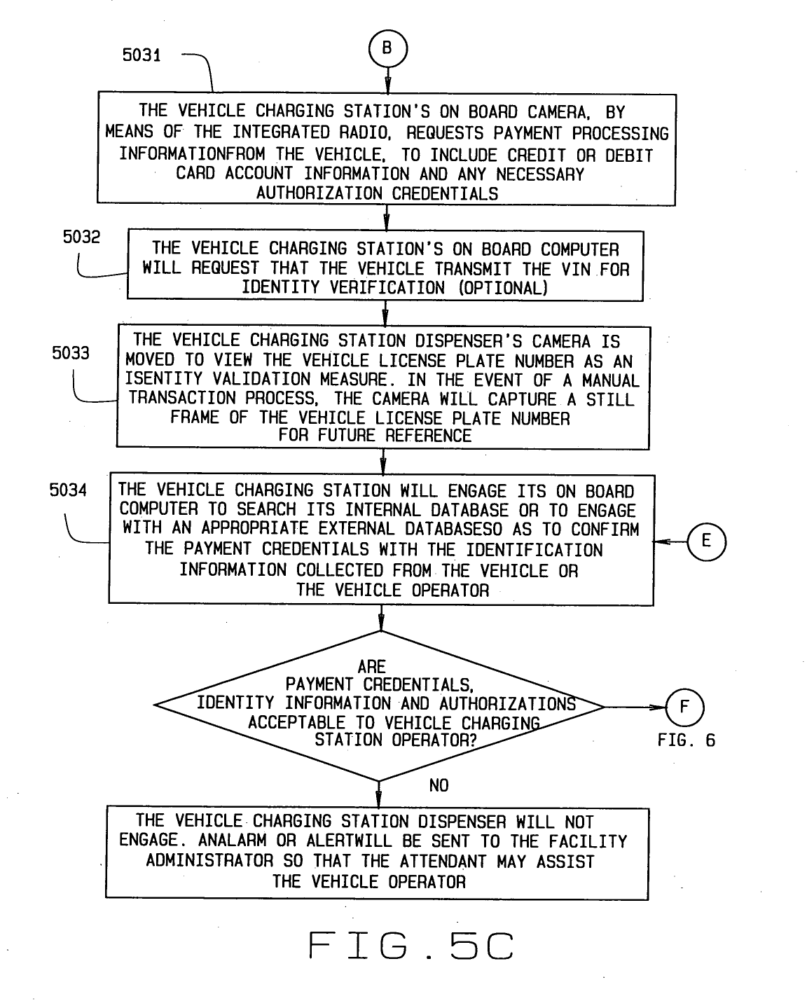

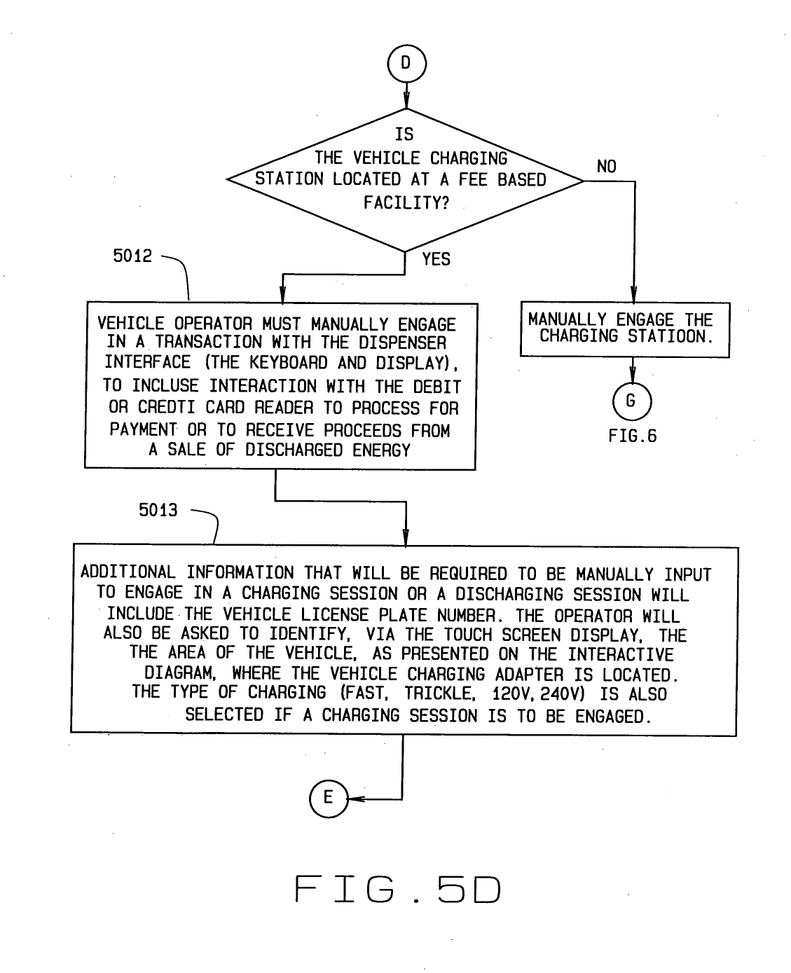

FIG. 5 shows the operation of the algorithm described in the Preferred Embodiment. The presence of the vehicle is noted by the motion detector 5001 and verified by camera 5002 at which point the automated vehicle charging system attempts to communicate with the vehicle 5003.

If the vehicle engages in communications and the vehicle owner wishes to engage in a charging or discharging session 5031, the automated vehicle charging system will confirm the identity of the vehicle 5032, 5033, 5034 and, if identity and payment credentials are acceptable, will communicate the rates at which energy will be offered for sale 6001.

Should the vehicle fail to engage in radio frequency based communications 5010 but yet the vehicle owner wishes to engage in a charging or discharging session 5011 then the vehicle owner may manually initiate a transaction with the automated vehicle charging station keyboard interface 5012, 5013. In the event that the vehicle owner enters into a space that is equipped for automated vehicle charging but does not wish to engage in a charging session 5004-5005, 5011 the automated vehicle charging system will identify the vehicle (by license plate) 5006, 5020 enabling the facility operator to charge perhaps higher parking fees for occupying a premium space 5007, 5021.

Should the vehicle enter a charging facility that is not fee based parking, at a residence for example, the motion detector 5001 and camera verification step 5002 are optional so that the automated vehicle charging system may rely on the radio frequency based communication 5002 to initiate (or not to initiate) a charging or discharging session.

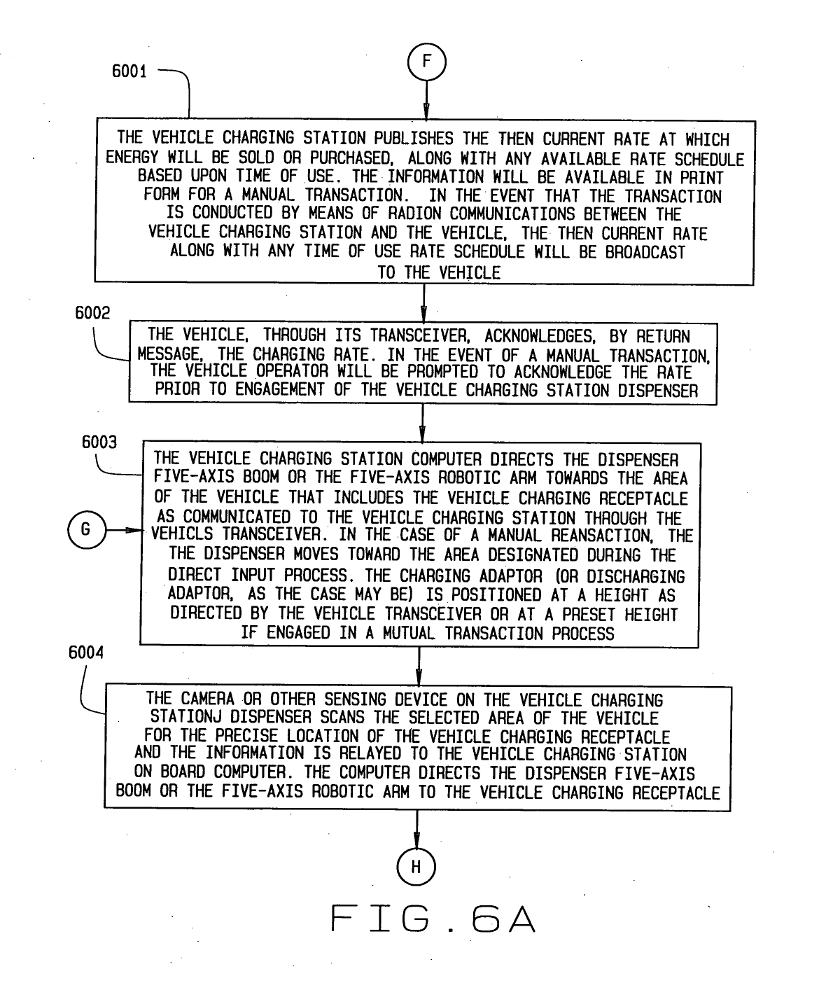

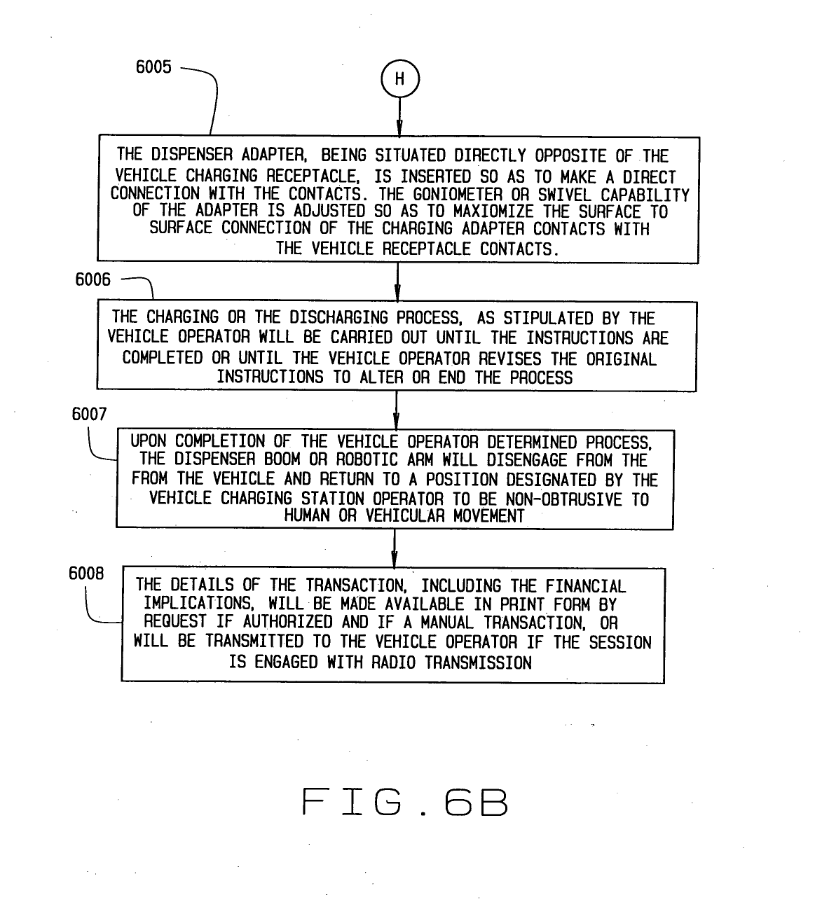

FIG. 6 shows the process of proceeding with a charging or discharging session after the vehicle owner receives information concerning the sales price of energy that will be made available by the automated vehicle charging station 6001. The vehicle owner must verify acceptance of the rate structure 6002 prior to the engagement of the automated vehicle charging system 6003. It is at this point that the automated vehicle charging system locates the vehicle charging receptacle 6004 and is seated in direct contact with the vehicle charging apparatus 6005 so that a charging or discharging session may take place 6006.

Once the charging or discharging session has concluded, the automated vehicle charging system will return to its idle position 6007 and a receipt detailing the economic consequences of the charging or discharging transaction will be provided to the vehicle owner 6008.

Variations or modifications to the subject matter of this invention may occur to those skilled in the art upon review of the invention as defined herein. Such variations, if within the spirit of this invention, are intended to be encompassed within the scope of any claims to patent protection provided herein. The description of the invention, and its depiction within these drawings, are primarily set forth for illustrative purposes only.

I claim:

1. An automated vehicle charging system for use on both hybrid electric vehicles and all-electric vehicles, comprising a dispenser, said dispenser incorporating means to accept payment in the form of a credit card reader, further incorporating a keypad and a display, and means for printing a receipt upon completion of a charging procedure, and additionally providing means for direct contact with the vehicle, such means extending from the dispenser having an alignable boom or robotic arm with extension, retraction, pivot, and swiveling capabilities, comprising a five-axis robotic arm providing of all of x, y z and goniometer actions, having flexibility to place an electric connector means directly into contact with the electrical receptacle provided upon the vehicle being serviced, including sufficient extension of the electric connector enabling direct connections with the vehicle receptacle, which vehicle receptacle is located at any position on the vehicle including the front, sides, or at the rear of the vehicle, said dispenser further comprised of a camera and sensors to provide for identification of the vehicle, which camera and sensors shall further assist to identify the location of the electric receptacle on the vehicle to provide information to be used for the final intricate movements of the automated movement of the boom or arm means into direct contact with the receptacle of the vehicle to be serviced and to engage such vehicle for a charging session or conversely discharging session, and such camera to furnish a means for identification of the vehicle for verification purposes, said dispenser capable of engaging at any given time in either a charging session or a discharging session, but only one such session at any given time, such dispenser being located at a parking facility, to include a garage or a lot, or to be established at a curbside location.

2. The automated vehicle charging system of claim 1, wherein the dispenser includes a plurality of boom means that provide for locating the charging connector into direct contact with the vehicle to be serviced.

3. The automated vehicle charging system of claim 1 wherein more than one vehicle may be charged at a time.

4. The automated vehicle charging system of claim 1 wherein the vehicle may be discharged, when the vehicle owner desires to sell back surplus energy for a credit particularly when energy cost may be elevated.

5. The automated vehicle charging system of claim 1 wherein the charging station may provide for inductive charging, wireless charging, or conductive charging, plug-in charging through a receptacle to the vehicle being charged.

6. The automated vehicle charging system of claim 1 wherein public transportation in the form of buses, cabs, or other vehicles may be recharged through the system of this invention.

7. The automated vehicle charging system of claim 1 wherein the charging station provides a charging adapter, such adapter also capable of facilitating a discharge of energy from a vehicle, which adapter automatically couples with the receptacle of a vehicle, through means of five-axis robotic mechanisms driven by a network of sensors and software.

8. The automated vehicle charging system of claim 1 wherein said system includes motion sensors and cameras to detect the presence of a vehicle within its proximity to be serviced.

9. The automated vehicle charging system of claim 1 wherein the dispenser includes a recognition system in the form of optics that provides for identification of a vehicle license plate number of the vehicle being serviced.

10. The automated vehicle charging system of claim 1 wherein the arm means comprises at least one five-axis robotic arm, wherein the five-axis robotic arm includes at least one alignment device utilizing one of a camera, laser, radar, or other means for detection to accurately align a charging connector with receptacle of the hybrid or electrical vehicle being serviced.

11. The automated vehicle charging system of claim 1 wherein the five-axis robotic arm provides for precise location in the electrical connector.

12. The automated vehicle charging system of claim 1, wherein the electric dispenser includes a battery to provide backup energy for its onboard computer, and said computer being capable of analyzing sensor inputs, aligns the five-axis boom or the five-axis robotic arm and its associated connector with the hybrid or electrical vehicle receptacle, communicates with the hybrid or electrical vehicle via wireless radio frequency, provides positive identification of the vehicle through any of its license plate, its vehicle identification number, its vehicle body style, the vehicle dimensions, and said computer detects credit card information authorized by the vehicle operator, and initiates connection procedures between the electrical connector of the dispenser with the vehicle receptacle and further initiates disconnect procedures as governed by the vehicle energy management system or directly by the operator of the vehicle through interaction with the dispenser keypad or wirelessly by radio frequency communication with the dispenser's radio enabled computer.

13. The automated vehicle charging system of claim 1, wherein the system, through its dispenser, calculates billings based upon energy flow to the hybrid or electric vehicle, calculates the applicable federal, state, and municipal billing charges, or determines the energy discharge from the electrical or hybrid vehicle, and provides for electric metering to furnish a net debit or credit with respect to the vehicle being serviced.

14. The automated vehicle charging system of claim 1 wherein the dispenser of the charging system incorporates means to perform system diagnostics on the overall charging operation of the hybrid or electric vehicle, and to notify the vehicle operator of any improper performance, malfunction, or other vehicle needs that should be repaired.

15. The automated vehicle charging system of claim 1 wherein the charging system can inductively deliver a charge to, through wireless connection, or inductively accept a discharge from the vehicle. The charging system shall be capable at any given point in time to deliver either a charge or to accept energy discharged as governed by the vehicle energy management system or directly by the operator of the vehicle through interaction with the dispenser keypad or wirelessly by radio frequency communication with the dispenser's radio enabled computer, provided that the dispenser shall not be capable of providing a charge and accepting a discharge simultaneously.
